(19) United States
(12) Patent Application Publication
(10) Pub. No.: US 2012/0036210 A1
(43) Pub. Date: Feb. 9, 2012

(54) SYSTEM AND METHOD TO USE COLLABORATIVE MIND MAPS

(76) Inventor: RAJARAM BALAJEE, Chennai (IN)

(21) Appl. No.: 13/227,568

(22) Filed: Sep. 8, 2011

(30) Foreign Application Priority Data
Mar. 9, 2009 (IN) 269/CHE/2009

(51) Int. Cl. G06F 15/16

(52) U.S. Cl. 709/206

(57) ABSTRACT

The present invention provides a system and method for effective and in-depth contextual online collaboration using mind maps. More particularly, the present invention provides the implementation of the “Quasi-Synchronous Collaboration” using collaborative mind map either in a hardware or software form or in the combination of both. The system and method referred as “Quasi-Synchronous collaboration” use collaborative mind maps for online collaboration overlaid with structured/per-defined communication providing advantages of both synchronous and asynchronous collaboration between various users for various purposes. Advantageously, the present invention could be used in several domains including the domains of e-learning, online demand/supply aggregation, project/program management, brainstorming, content creation, content review, etc.

### FIELD OF INVENTION

The present invention relates to a system and method of effective and in-depth contextual online collaboration using mind maps. Further the present invention relates to the implementation of the “Quasi-Synchronous Collaboration” using collaborative mind map either in a hardware or software form or in the combination of both. The system and method referred as ‘Quasi-synchronous collaboration’ uses collaborative mind maps for online collaboration overlaid with structured/pre-defined communication providing advantages of both synchronous and asynchronous collaboration between various users for various purposes. The Quasi-Synchronous Collaboration approach could be used in several domains including the domains of e-learning, online demand/supply aggregation, project/program management, brainstorming, content creation, content review etc. Also, the present invention enables mind-maps to be embedded in any online application and facilitates collaboration between multiple users. Thus it extends the ‘Quasi-Synchronous Collaboration’ to multiple applications. For example Online Chat, Mobile SMS, Tweets, Blogs and any online content can be extended to provide in-depth contextual collaboration between multiple users. It builds mind-maps automatically in the back-ground and brings in mind-map views as and when required to fore-ground, while allowing natural user-interfaces of various applications to be in the fore-front for users to operate.

### BACKGROUND OF THE INVENTION

A mind map is a diagram used to represent words, ideas, tasks, or other items linked to and arranged radically around a central key word or idea. Mind maps are used to generate, visualize, structure, and classify ideas, and as an aid in study, organization, problem solving, decision making, and writing. The elements of a given mind map are arranged intuitively according to the importance of the concepts, and are classified into groupings, branches, or areas, with the goal of representing semantic or other connections between portions of information. Mind maps may also aid recall of existing memories.

There is a root idea from which several ideas branch and each branch idea gives rise to several other branch ideas. Each idea is technically called a ‘node’. Typically Mind Map is used in learning to enable student to memorize and understand the concepts better. In online and offline domains, mind-map is used for these purposes currently.

Online domain refers to functions carried out over internet accessed through computers, mobile phones or any other means or in logical world of computers through software. Offline domain refers to functions carried out in physical world through the use of hardware and software or a combination of both.

In offline world, collaborative mind map is currently not used for any significant purpose; though the concept of Collaborative mind map exists.

In online world, collaborative mindmap is currently used as the front-end for solving several problems, but is not popular and effective. The reasons are:

Currently the concept of collaborative mind maps is restricted to multiple users joining together to create a mind-map. They do not facilitate effective contextual collaboration between various users, though they are very effective in representing particular set of concepts.

In particular they have not been thought through and applied for content independent collaboration and in-depth contextual collaboration between various users, which calls for innovative structures and methods on top of collaborative mind-maps.

Collaborative mindmaps become large, messy and difficult to handle as they scale up. Further they are not good as user interface mediums for entering data, however good-looking they are made.

Further collaborative mind-maps allow only content to be added directly into mind-maps and do not allow a method to add both communication around the content and the content into the same mind-map.

Further if and when content and communication around the content are put in the same mind-map they are not distinguishable and cannot be segregated.

Since they cannot be segregated, if communication happens around the content, then content resulting from the communication cannot be segregated and added back into the content mind-map.

Also in a typical collaboration it is possible that multiple ideas are discussed and users may want to automatically categorize the ideas.

Similarly there may be a need to classify particular communications (for eg all questions for all answers) in a mind-map. But these kind of categorization and classification are not possible in current day collaborative mind-maps.

There has thus been a persistent need in the art to develop a system and method to deploy collaborative mind-maps for effective and in-depth contextual collaboration between various users either in online domain or offline domain. The objects, advantages and novel features of the invention may be realized and obtained by means of the instrumentalities and combinations particularly pointed out in the detailed description.

### OBJECTS OF THE INVENTION

It is thus the basic object of the present invention to provide a system and method of online quasi-synchronous collaboration using collaborative mind maps between various users for multiple purposes.

It is another object of the present invention to provide a new technique called quasi-synchronous collaboration comprising of:

Collaborative mind map layer;

Structured, pre-defined communication layer on top of collaborative mind map layer called Contextual Communication Layer;

Methods and Tools that facilitate contextual collaboration layer having advantages of both synchronous and asynchronous collaboration.

A still further object of the present invention is to provide online quasi-synchronous collaboration using collaborative mind maps which enables contextual collaboration amongst single/multiple users online and offline.

A still further object of the present invention is to provide a system and method for online quasi-synchronous collaboration using collaborative mind maps to record all the transactions that happened during the collaboration through audio, video or text.

A still further object of the present invention wherein the pre-defined structured communication present in the Contextual Communication Layer is mutually agreed between users or defined by the system permanently or varies from session to session.

It is another object of the present invention wherein the pre-defined structured communications in the Contextual Communication Layer can classify communications transacted between multiple users. The examples of classification of communication between users include and not limited to questions, answers, reviews, comments, doubts etc. This is the communication around the content of the mind-map or could be a basic communication to build the content of the mind-map.

It is another object of the present invention wherein the content part of the multi-user communications can also be further categorized using the pre-defined structure communications in the Contextual Communication Layer. Thus not only that content can be segregated from communication, but it also be further categorized. The examples of this categorization of communication are including but not limited to Idea A, Idea B, Idea C etc.

It is another object of the present invention, wherein access, filtering, representation and display of data that is accumulated through structured communication and contextual collaborative communication in a collaborative mind map to users is provided.

It is another object of the present invention, wherein interfaces are defined at collaborative mind-map that enables mind-maps to interface with applications and function from the background. It enables end-users to work with existing user interfaces of applications, while mind-maps get built in the back-ground automatically and invoked on need basis by end-users. The online applications are including but not limited to any online content, emails, blogs, tweets, chats, conferences, mobile SMS, MMS, webinars, webcasts etc

It is another object of the present invention, wherein automatic building of collaborative mind-maps is performed from unstructured/semi-structured data entered by the users or collected from the online applications.

It is another object of the present invention, wherein automatic summarization of collaborative mind-maps is performed based on categorization and classification of content and communication parts of mind-map, said summarization includes text, graphs and numbers.

It is another object of the present invention, wherein the content part of collaboration is automatically added back to the base collaborative mind-map, thus automatically adding to the content.

It is another object of the present invention, wherein the communication part of mind-map is automatically pushed back to the different users through different interfaces like emails, chats, blogs, tweets, SMS, MMS or any other interface through which the users collaborated.

It is another object of the present invention, wherein any kind of computation operations (arithmetic, logical, statistical etc) on collaborative mind-maps and between multiple collaborative mind-maps is performed for aggregating data between multiple users and machines

It is another object of the present invention to provide a system and method for online synchronous collaboration using collaborative mind maps for the purposes which includes:
Collaboration in e-learning and online learning.
Collaboration in demand/supply aggregation
Collaboration in brainstorming.
Collaborative reviews of content including books, text, audio, video, movies, images, photos and any type of content.
Collaboration for Program Management and Project Management.
Online web conferences and meetings.
Collaboration between multiple users using mobile SMS, MMS and Chats
Collaboration between multiple users using tweets, blogs etc
Collaboration between multiple users to aggregate demand, supply information
Collaboration to aggregate data of any form between multiple users or machines

### SUMMARY OF THE INVENTION

Thus according to the basic aspect of the present invention there is provided a system for online Quasi-Synchronous Collaboration between various users comprising:

Contextual Communication Layer on top of collaborative mind-map layer which is a structured, pre-defined communication layer adapted to have the advantages of both synchronous and asynchronous collaboration between one user to one user, one user to many users, many users to one user, many users to many users, all users to one user, all users to all users and one user to all users;

wherein said structured, pre-defined communication layer involves messages and tags that are pre-defined and mutually agreed between users and include messages and tags for the content or communication part or both

wherein said structured, pre-defined communication layer classifies the communication part using the said messages and tags, said classification of communication between users includes but not limited to questions, answers, reviews, comments, doubts etc.

wherein said structured, pre-defined communication layer categorizes the content part using the said messages and tags, said categorization includes but not limited to idea A, idea B, idea C, User A, User B, User C etc

wherein the structured pre-defined communications could be permanently defined or defined in a manner that varies session to session,

wherein said contextual communication layer facilitates in-depth analyzing of related/unrelated ideas by communicating around the concept without requiring direct simultaneous presence of users at any given time and allowing users to communicate effectively though they are in different time-zones,

wherein said contextual communication layer involves invoking structured, pre-defined communications over the nodes of collaborative mind-map, segregates the content part and communication part of collaboration and adds all the content part that results out of contextual communication layer automatically back to the mind-map,

wherein said contextual communication layer segregates all the communication part of the collaboration into a separate mind-map that is accessible to users at any given time,
wherein said contextual communication layer pushes out all communication part of the collaboration back to users through defined user interfaces of applications through which users invoked the collaboration, and
wherein said system is adapted for storing and retrieving all communications and data emanating during the collaboration.

Another aspect of the present invention is directed to provide a method, wherein the method provides automatic summarization and updating of collaborative mind-maps covering all the nodes of a mind-map based on categorization and classification of communication and content, said summarization includes text, graphs and numbers.

Another aspect of the present invention is directed to provide a method, wherein the method provides aggregating and carrying out various computation operations (arithmetic, logical, statistical) on collaborative mind-maps and between collaborative mind-maps

Another aspect of the present invention is directed to provide a method, wherein the method provides interfaces to various applications, said applications include online chat, review of document or information browsing of any online site, emails, blogging, tweeting, online audios and videos, online audio and video chats, online webinars, online voip conferences, etc, said information being text, audio or video.

A still further aspect of the present invention directed to provide a method, wherein the method provides creation of automatic collaborative mind-map nodes dynamically is made possible when user keys in data or from documents or from stored information or from conventional user interfaces of applications, without the need of providing data explicitly in a mind-map form

A still further aspect of the present invention is directed to a method, that enables mind-maps to be automatically invoked from various existing applications and use it either in the fore-ground at user end or in the background for computational and decision making purposes.

Another aspect of the present invention is directed to provide a method, wherein the method enables creation of automatic collaborative mind-maps from unstructured/semi-structured data entered by the users or collected from the online application.

Another aspect of the present invention is directed to provide a method wherein provides accessing, filtering, representing and displaying of data that is accumulated through said structured communication layer and contextual communication layer to the users.

Another aspect of the present invention is directed to provide a system for online quasi-synchronous collaboration between various users, wherein the said implementation of software could be in either a package form or in the form of online service.

The present invention and its objects and advantages are described hereunder in greater detail with reference to the following exemplary non-limiting illustrative Figures.

### BRIEF DESCRIPTION OF THE ACCOMPANYING FIGURES

FIG. 1: is the schematic illustration of the logical architecture diagram of Quasi-Synchronous collaboration technique

FIG. 2: is the schematic illustration showing the physical architecture diagram of online quasi-synchronous collaboration.

FIG. 3: is the schematic illustration of the documentation review using Quasi-Synchronous collaboration (QSC) and Contextual Communication Layer (CCL).

FIG. 4: is the schematic illustration of a Chat using Quasi-Synchronous collaboration (QSC) and Contextual Communication Layer (CCL).

### DETAILED DESCRIPTION OF THE INVENTION WITH REFERENCE TO THE ACCOMPANYING FIGURES

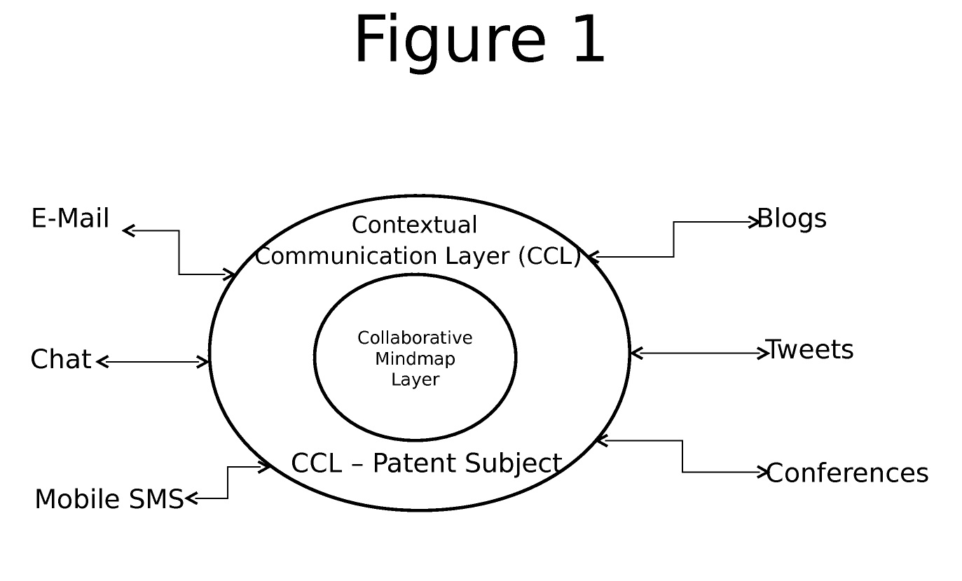

Reference is first invited to the accompanying FIG. 1, which illustrates the schematic illustration of logical architecture of technique of quasi-synchronous collaboration comprising Contextual Communication Layer (CCL) on top of collaborative mind-map layer. The CCL, which is a structured, pre-defined communication layer adapted to have the advantages of both synchronous and asynchronous collaboration, interfaces with applications from blogs, tweets, chats, emails and conferences. It also interfaces with SMS, MMS from mobiles providing the advantage of mind-maps to these applications without them actually getting into mind-maps.

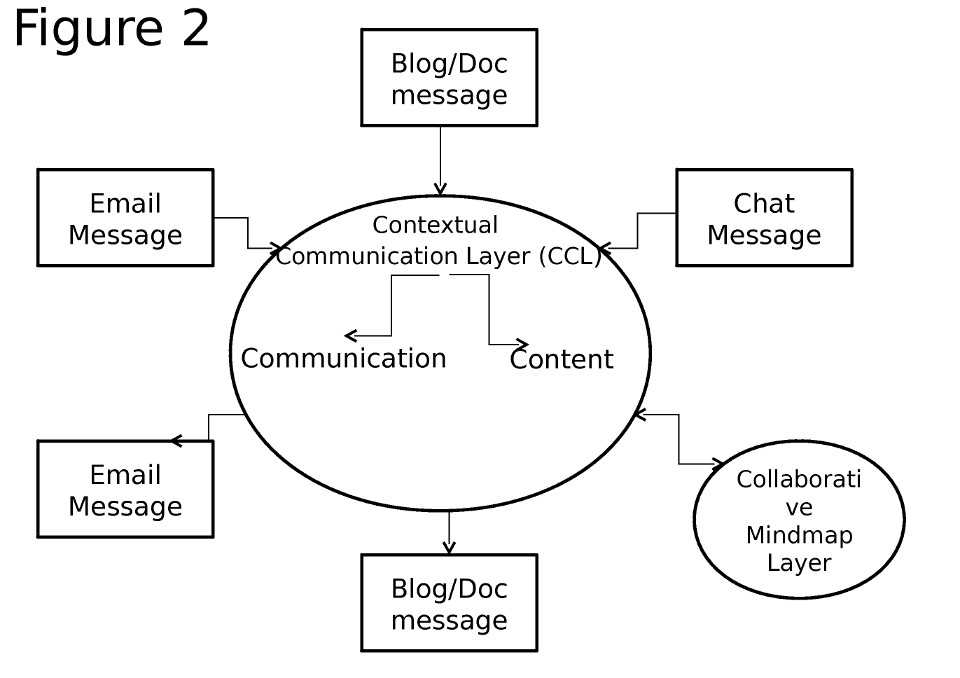

FIG. 2 schematically illustrates the physical architecture of technique of online quasi-synchronous collaboration according to the present invention.

Users using different applications as mentioned above originate messages to CCL. They also tag their communication to CCL with appropriate meaningful tags. The tagging of communication is either done by the users or done by the applications through appropriate user-interfaces. The CCL receives these messages with appropriate tags of communication and builds a collaborative mind-map at the Collaborative mind-map layer. The CCL builds the mind-map of content into the content mind-map. The CCL isolates the communication part and pushes it to end-users through their existing user interfaces. Thus users continue to be in their existing applications and user interfaces while mind-map gets built automatically.

The CCL can also build a mind-map of this communication part if required. The CCL can in fact build several content mind-maps and communication mind-maps based on the tags simultaneously for a session of collaboration between multiple users. The tags can be used to categorize content and classify communication as described previously.

The end-users can pull up a mind-map view of their collaboration at any given time for reference. The CCL also provides a way for storing and retrieving all communications and data emanating during the collaboration.

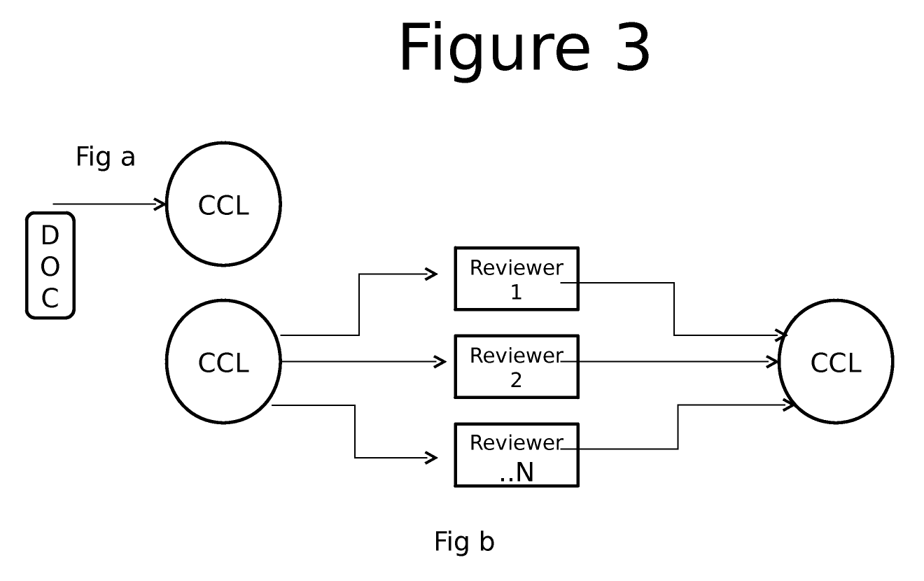

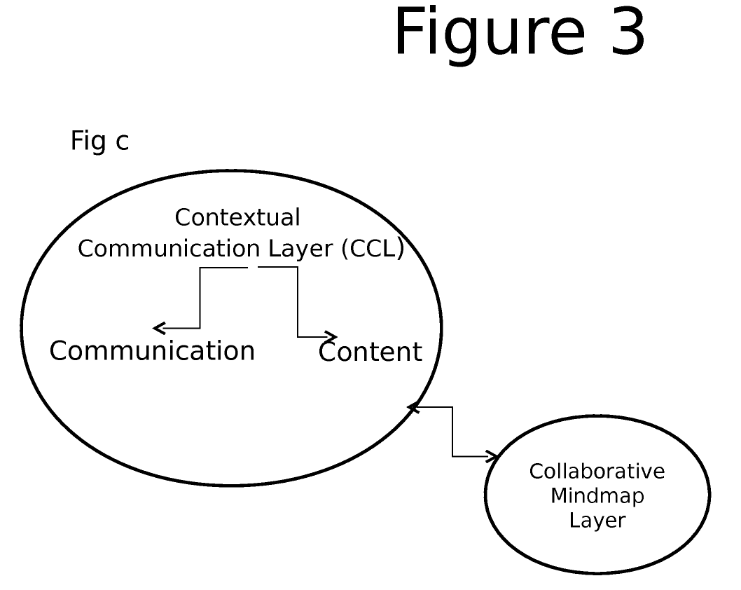

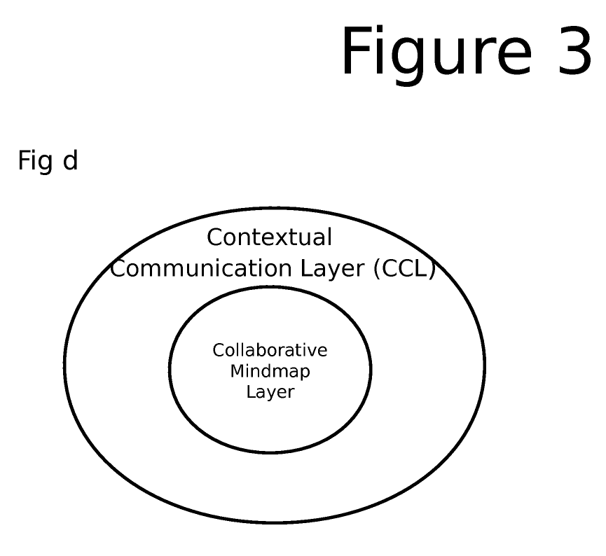

Reference is now invited to the accompanying FIG. 3, which schematically illustrates the technique of Quasi-synchronous collaboration (QSC) according to the present invention for the purpose of a ‘document’ review.

Document is sent to CCL with the information on whom to review what. This information is sent through a system of messages and tags to CCL. The CCL creates a mind-map view of the document. This is shown in FIG. (a) of FIG. 3.

The CCL then starts a collaboration session by inviting the people mentioned and providing them the document parts to review on mail. Reviewers have an option to use the mind-map view also to review the document. As reviewers review the document, they send in their comments, questions, answers, doubts, notes etc to CCL, which shares it with the relevant reviewers. FIG. (b) of FIG. 3. This communication between reviewers and CCL is done through a system of messages and tags. Questions by a reviewer are added to communication part of mind-map as well as sent to all reviewers. Questions are answered by other reviewers as well as the initiator of review. Answers are added to communication part of mind-map as well as sent to all reviewers. Doubts by reviewer are added to communication part as well as sent to initiator of review. They are answered by initiator and added to communication part of mind-map. Comments by reviewer are sent to other reviewers. Till the time comments are accepted they are added to a separate comment mind-map. Comments keep on flowing between reviewers. Once accepted by initiator, comments are summarized and the finalized comment is added to the content part of the mind-map FIG. (c) of FIG. 3.

Questions, Answers, Doubts, Comments, Notes, Acceptance are all communicated between the applications and CCL through a system of pre-defined structured communication of messages and tags. All Collaborations are updated at the mind-map by CCL. The users can invoke a mind-map view at any stage of collaboration (FIG. d) of FIG. 3. The messages and tags of communication between applications and CCL are not limited to the above alone, but given as an example. The messages and tags could be permanently defined or one that varies session to session, based on an understanding between users. The collaboration could be one user to one user, one user to many users, many users to one user, many users to many users, all users to one user, all users to all users, one user to all users etc. The form of messages could be text, audio, video, files, images, photos, web links etc.

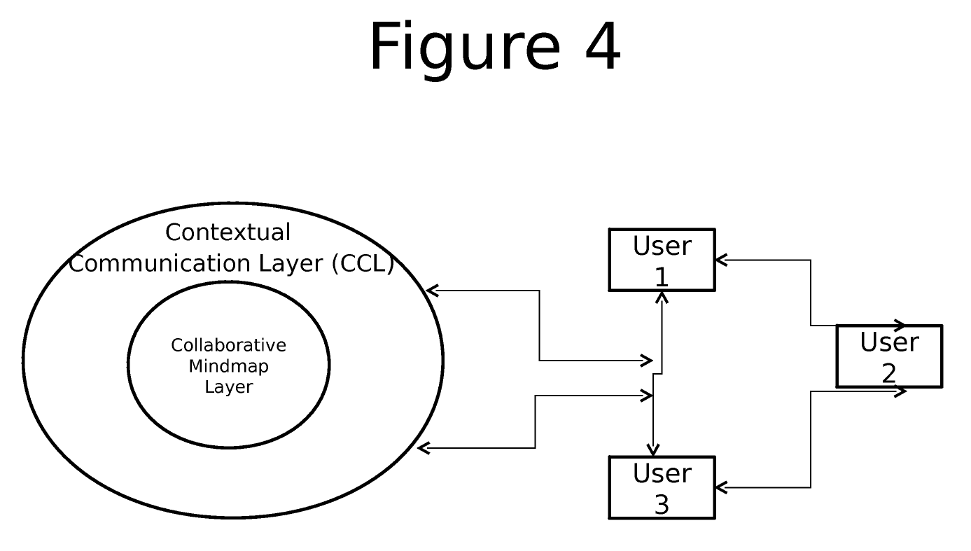

Reference is now invited to FIG. 4, which schematically illustrates a chat session between multiple users using QSC and CCL.

Multiple users use their conventional chat interface and start chatting between them. Their communications are sent to CCL through a structured, pre-defined communication scheme of messages and tags. The tags of communication are manually appended by users or automatically done the system. The CCL receives these messages and tags and builds a mind-map of these.

The users send in their discussion ideas, comments, questions, answers, doubts, notes etc to CCL, which shares it with other users. CCL starts building a content mind-map with Discussion ideas. Questions by a user are added to communication part of mind-map as well as sent to all users. Questions are answered by other users. Answers are added to communication part of mind-map as well as sent to all users. Comments by users are sent to other users. Till the time comments are accepted by a majority of users they are added to a separate comment mind-map. Comments keep on flowing between users. Once accepted by majority, comments are summarized and the finalized comment is added to the content part of the mind-map.

Questions, Answers, Comments, Notes, Acceptance are all communicated between the applications and CCL through a system of pre-defined structured communication of messages and tags. All Collaborations are updated at the mind-map by CCL. The users can invoke a mind-map view at any stage of collaboration. The messages and tags of communication between applications and CCL are not limited to the above alone, but given as an example. The messages and tags could be permanently defined or one that varies session to session, based on an understanding between users. The collaboration could be one user to one user, one user to many users, many users to one user, many users to many users, all users to one user, all users to all users, one user to all users etc. The form of messages could be text, audio, video, files, images, photos, web links etc.

I claim:

1. A system for online Quasi-Synchronous Collaboration between various users comprising: Structured, pre-defined communication layer adapted to have the advantages of both synchronous and asynchronous collaboration between various users, which enables said contextual communication on top of a collaborative mind-map layer herein referred as “Contextual Communication Layer”;
wherein said structured, pre-defined communication layer involves messages and tags that are pre-defined and mutually agreed between users,
wherein the pre-defined messages and tags could be permanently defined or defined in a manner that varies session to session,
wherein said contextual communication layer provides in-depth analyzing of related/unrelated ideas by enabling communication around the concept without requiring direct simultaneous presence of users at any given time and allowing users to communicate more effectively though they are in different time-zones,
wherein said contextual communication layer segregates all the communication part of the collaboration from the content part of the collaboration using the messages and tags,
wherein said contextual communication layer automatically builds mind-maps out of the content part of collaboration using the collaborative mind-map layer,
wherein said contextual communication layers adds automatically the newer content parts resulting out of collaboration back into the collaborative mind-map,
wherein said contextual communication layer further categorizes the content into smaller separate mind-maps using the messages and tags,
wherein said contextual communication layer further classifies the communication part of collaboration into smaller units and creates separate smaller mind-maps that can be referred by users at any time,
wherein said contextual communication layer pushes back the communication part of collaboration back to users through their existing applications and user interfaces, and
wherein said system is adapted for storing and retrieving all communications and data including text, audio and video emanating during the collaboration.

2. A method of implementing online Quasi-Synchronous Collaboration between various users in the said system according to claim 1 comprising: providing automatic summarization and updating of one or more collaborative mind-maps and between mind-maps covering one or more of the nodes of mind-maps based on categorization and classification of communication and content, said summarization includes text, graphs, audio, videos and numbers.

3. A method of implementing online Quasi-Synchronous Collaboration between various users in the said system according to claim 1, wherein the said method provides aggregation and carrying out various computation operations (arithmetic, logical, statistical) on one or more collaborative mind-maps and between collaborative mind-maps.

4. A method of implementing online Quasi-Synchronous Collaboration between various users in the said system according to claim 1, wherein the said method provides interfaces to one or more of applications, said applications include online chat, review of document or information browsing of any online site, emails, blogging, tweeting, online audios and videos, online audio and video chats, online webinars, online voip conferences, etc, said information being text, audio or video.

5. A method of implementing online Quasi-Synchronous Collaboration between various users in the said system according to claim 1, wherein said method provides creation of automatic collaborative mind-map nodes dynamically is made possible when user keys in data or from documents or from stored information or from conventional user interfaces of applications, without the need of providing data explicitly in a mind-map form on the mind-maps.

6. A method of implementing online Quasi-Synchronous Collaboration between various users in the said system according to claim 1, wherein the said method is embedded in various applications, which if invoked enables mind-maps to be automatically invoked from various existing applications and use it either in the fore-ground at user end or in the background for computational and decision making purposes.

7. A method of implementing online Quasi-Synchronous Collaboration between various users in the said system according to claim 1, wherein the said method provides accessing, filtering, representing and displaying of data that is accumulated through said contextual communication layer to the users.

8. The system for online Quasi-Synchronous Collaboration between various users according to claim 1, wherein the said collaboration could be implemented in either a hardware or software form or in the combination of both.

9. The system for online Quasi-Synchronous Collaboration between various users according to claim 8, wherein the said implementation of software could be in either a package form or in the form of online service.
